(19) United States
(12) Patent Application Publication
(10) Pub. No.: US 2024/0006624 A1
(43) Pub. Date: Jan. 4, 2024

(54) FREE-STANDING, ION-SELECTIVE COMPOSITE MEMBRANES

(71) Applicant: Amtek Research International LLC, Lebanon, OR (US)

(72) Inventors: Daniel Wandera, Chandler, AZ (US); Robert Waterhouse, Lebanon, OR (US); Andrew Wimer, Lebanon, OR (US); Richard W. Pekala, Corvallis, OR (US); Haley Heron, Corvallis, OR (US)

(21) Appl. No.: 18/255,063

(22) PCT Filed: Dec. 6, 2021
(86) PCT No.: PCT/US2021/072764

§ 371 Date: May 30, 2023

Related U.S. Application Data
(60) Provisional application No. 63/125,361, filed on Dec. 14, 2020.

(51) Int. Cl. H01M 8/0245; H01M 8/18; H01M 8/0239; H01M 8/0243; H01M 8/0236; H01M 8/0234

(52) U.S. Cl. CPC H01M 8/0245; H01M 8/188; H01M 8/0239; H01M 8/0243; H01M 8/0236; H01M 8/0234

(57) ABSTRACT

This disclosure relates to free-standing, composite membranes that include an ion-selective polymer coating that covers at least one surface and partially penetrates into the pore structure of a polyolefin substrate. While the composite membranes do not have open, interconnected pores that connect each major surface, ion transport can take place through wetting of available pores and swelling of the ion-selective polymer coating accompanied by ion migration from one membrane surface to the opposite surface. Such composite membranes are useful for separating the anolyte and catholyte in a flow battery.

### RELATED APPLICATIONS

This application claims priority to U.S. Provisional Application No. 63/125,361, filed Dec. 14, 2020, titled ASYMMETRIC, FREE-STANDING, ION-SELECTIVE COMPOSITE MEMBRANE, which is incorporated herein by reference in its entirety.

### COPYRIGHT NOTICE

© 2021 Amtek Research International LLC. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

This disclosure relates to free-standing, composite membranes that include an ion-selective polymer coating that covers at least one surface and partially penetrates into the pore structure of a polyolefin substrate. While the composite membranes do not have open, interconnected pores that connect each major surface, ion transport can still take place through wetting of available pores and swelling of the ion-selective polymer coating accompanied by ion migration from one membrane surface to the opposite surface. Such composite membranes are useful for separating the anolyte and catholyte in a flow battery.

### BACKGROUND

Energy storage from renewable resources such as wind and solar power is becoming increasingly important to the electric utility industry. Large-scale energy storage applications can help to mitigate climate change and allow utilities to improve system reliability and performance, smooth out power costs, and enable 24/7 consumption of renewable energy.

To achieve the above objectives, utility companies are investigating a variety of battery technologies. Lead-acid batteries have been commonly used because of their low cost, reasonable energy density, and their ability to discharge under high current loads. The cycle life of the lead-acid battery is a disadvantage compared to other battery chemistries. Li-ion batteries are also being utilized in large-scale storage systems. While such batteries have outstanding energy density and excellent cycle life, they suffer from safety issues because the organic electrolyte can result in a fire and explosion. Sodium-sulfur batteries have also been investigated because of their high energy density, yet their operational costs are high because of a required operating temperature at 300-350 C.

More recently, flow batteries have been investigated for large-scale, renewable power facilities. Flow batteries store electricity in liquid electrolytes that reside in storage tanks and are pumped through the cell during charge and discharge cycles. The flow battery consists of two half-cells that are divided by an ion-selective membrane that separates and insulates the two sides from each other. Flow batteries have been demonstrated with a variety of redox couples in multivalent vanadium and iron compounds that are water soluble. The aqueous electrolyte is attractive for safety and other reasons. While all flow batteries suffer from low energy density because of their large liquid storage tanks, they are an attractive option for wind or solar farms that are typically located in rural areas with low land costs.

One of the keys to achieving high efficiency and long cycle life in a flow battery is the ion-selective membrane. Such membranes must have excellent chemical stability and long-life durability, while preventing cross-over contamination. Furthermore, the membrane must have low specific ionic resistance for transport between the half-cells. In order to prevent cross-over contamination and reduced cycle life, it is desirable to have a composite membrane that exhibits excellent mechanical properties having a porous, aqueous-wettable bulk substrate that is coated on one or both sides with an ion-selective polymer-rich, non-porous layer. In some embodiments, the composite membrane is only coated with an ion-selective, polymer-rich, non-porous layer on one side, while the other side remains uncoated, porous, and capable of being thermally, ultrasonically, or adhesively bonded to a frame that can be stacked to form multiple cells in series or parallel. In other embodiments, the composite membrane is coated on both sides with an ion-selective, polymer-rich, non-porous layer. The ion-selective, polymer-rich, non-porous layer can also be crosslinked as further detailed below.

### BRIEF DESCRIPTION OF THE DRAWINGS

The embodiments disclosed herein will become more fully apparent from the following description and appended claims, taken in conjunction with the accompanying drawings. These drawings depict only typical embodiments, which will be described with additional specificity and detail through use of the accompanying drawings in which:

FIG. 1 is a cross-sectional schematic view of an asymmetric, composite membrane having an ion-selective, non-porous layer on one side of the membrane.

FIG. 2 is a cross-sectional schematic view of a composite membrane having an ion-selective, non-porous layer on both sides of the membrane.

FIG. 3 is an image of an exemplary composite membrane having a coating disposed thereon.

FIG. 4 is a cross-sectional view of a schematic of the apparatus used to measure electrical resistance of the composite membrane samples disclosed herein.

FIG. 5 is a perspective view of a schematic of the apparatus used to measure electrical resistance of the composite membrane samples disclosed herein.

FIG. 6 is a scanning electron microscopy (SEM) image of a coated surface of a composite membrane made in accordance with an embodiment of the disclosure.

FIG. 7 is an SEM image of an uncoated surface of a composite membrane made in accordance with an embodiment of the disclosure.

FIG. 8 is an image of the apparatus used to measure the rate of ferric chloride crossover of the composite membrane samples disclosed herein.

FIG. 9 is a graph demonstrating the absorbance vs. wavelength as used herein to determine the rate of ferric chloride crossover of the composite membrane samples.

FIG. 10 is a graph of a calibration curve showing absorbance vs. ferric chloride concentration as used herein to determine the rate of ferric chloride crossover of the composite membrane samples.

FIG. 11 is a graph comparing the electrical resistivity (Ω-cm) of various composite membrane samples disclosed herein.

FIG. 12 is a graph comparing the ferric chloride diffusion rate (mol/hr/m²) of various composite membrane samples disclosed herein.

### DETAILED DESCRIPTION

While Nafion® and other ion-selective polymers have been cast or extruded into films (otherwise referred to herein as webs or membranes) for fuel cell and other energy storage applications, these materials suffer from poor mechanical properties, particularly when wet. In addition, the ion-selective polymer is expensive; therefore, it is desirable to minimize the thickness of the film or web even though a thinner film or web is more difficult to handle. Furthermore, it is difficult to bond such polymers as Nafion® to other surfaces.

An advantage of the present disclosure is the ability to produce a free-standing ion-selective membrane for applications in flow batteries or other energy storage devices. This advantage is accomplished by combining a microporous polyolefin substrate with an ion-selective coating to form a composite membrane. In particular embodiments, disclosed herein are composite membranes containing a freestanding, microporous polyolefin substrate (otherwise referred to as a web) comprising a polyolefin and a high surface area, hydrophilic filler. The microporous polyolefin substrate has a bulk structure that extends from a first major surface to a second major surface. The bulk structure has 40-75% porosity, is wettable with an aqueous electrolyte, and includes a high surface area, hydrophilic filler distributed throughout the bulk structure. In some instances, the volume fraction of filler divided by the volume fraction of polyolefin is greater than 0.75, or greater than 1.0, such as between 0.75 and 1.3. In some embodiments, the first major surface is uncoated and includes open pores, readily penetrable by aqueous electrolyte into the porosity of the bulk structure. The second major surface can have a non-porous coating of an ion-selective polymer that results in lower air permeability and liquid permeability. In other embodiments, both major surfaces (i.e., the first and second major surfaces) have a non-porous coating of an ion-selective polymer that results in lower air permeability and liquid permeability.

“Freestanding” refers to a web or membrane having sufficient mechanical properties for use in unwinding, coating, winding, slitting and other web handling operations. The terms “film,” “sheet,” “substrate”, “web,” and “membrane” can be used interchangeably.

The microporous polyolefin substrate is freestanding, has 40-75% porosity, and is wettable with aqueous solutions that are commonly used in electrolytes for flow batteries. To impart such wettability to the polyolefin substrate, it is desirable to incorporate a large quantity of a high surface area, hydrophilic filler such as precipitated or fumed silica. Because the volume fraction and orientation of the polymer in the microporous substrate impacts tensile strength and puncture strength, it desirable to use ultra-high molecular weight polyethylene (UHMWPE) or a blend that includes it as part of the polymer matrix.

While lead-acid separators are commonly produced from UHMWPE and precipitated or fumed silica, they typically contain 10-20% of residual process oil to improve the oxidation resistance of the separator. Residual oil is less desirable for composite membranes used in flow batteries. As such, it is important to carefully select the process oil such that the process oil is easily extracted to leave behind a minimal residual content in the microporous polyolefin sheet. In flow battery applications, exemplary process oils that can be used include, but are not limited to, paraffinic oils, naphthenic oils, mineral oils, plant-based oils, and mixtures thereof. In a particular embodiment, the resultant microporous polymer substrate, post-extraction of the process oil, contains less than 3% process oil, or even more preferably, less than 2% process oil.

The ion-selective polymer coating prevents or minimizes the migration of electrochemically active species (e.g., cations) from the anolyte to the catholyte, or vice versa. Such migration results in a loss of current efficiency in the battery and can lead to shorter operating lifetimes. In some embodiments, a coating is chosen that does not excessively impede the transport of the charge-carrying ions between the electrodes. Resistance to flow of these ions will result in reduced voltage efficiency of the battery. The polymer coating resists fouling and maintains integrity over the operating life of the battery.

The optimization of the ion-selective polymer coating is contingent upon flow battery chemistry, but in general, the polymer swells in water and contains anhydride, carboxylic acid, and/or sulfonic acid groups. Traditional ion-selective polymers that have been used include, but are not limited to, perfluorosulfonic acid/polytetrafluoroethylene copolymers (Chemours; Nafion®) and tetrafluoroethylene-sulfonyl fluoride vinyl ether copolymers (Solvay; Aquivion®). Other fluoropolymers such as polyvinylidene fluoride and its copolymers can be chemically modified with ion-exchange head groups to render them suitable as ion-selective polymers. Non-fluorinated and/or non-halogenated polymers can also be used as the ion-selective polymer. Such polymers include, but are not limited to, polymethacrylic acid and methacrylic acid copolymers, polyacrylic acid and acrylic acid copolymers, sulfonated polyethersulfone, sulfonated polystyrene and sulfonated styrene copolymers, polymaleic anhydride and maleic anhydride copolymers, and sulfonated block copolymers (Kraton; Nexar™) Additional, non-limiting examples of polymers that can be modified to be ion-selective include poly ether ketone (PEEK), poly phenylene oxide (PPO), polyimide (PI), poly benzimidazole (PEI), poly arylene ether sulfone (PAES), and combinations thereof. These polymers can be sulfonated, carboxylated, or otherwise modified to make them ion-selective polymers.

The ion-selective polymer can also be crosslinked, such as via irradiation, free radicals, or chemical cross-linking. Various types of crosslinking agents or crosslinkers can be used. For instance, the crosslinkers can be activated by functional groups (e.g., NH₂, OH, etc.) on the ion-selective polymer, other chemical agents, heat, pressure, change in pH, light (e.g., UV light), or irradiation. In particular embodiments, polyfunctional aziridines are used as crosslinking agents. Other types of crosslinkers can also be used including, but not limited to, polyfunctional isocyanates, epoxides, amines, phenolics, and anhydrides, etc.

The ion-selective polymer can further include nanoparticulate fillers. Examples of the nanoparticulate fillers include: metal oxides such as SiO2, TiO2, ZrO2, SnO2, and Al2O3; metal phosphates such as zirconium phosphate, titanium phosphate, and boron phosphate; phosphosilicates such as P205-SiO2 and Metal oxide-P205-SiO2; zeolites such as natural (chabazite, clinoptilolite, mordenite) and synthetic; hetero polyacids such as phosphotungstic acid, phosphomolybdic acid, and silicotungstic acid; carbon materials such as carbon nanotubes, activated carbon, and graphene oxide; metal-organic frameworks (MOF's); and combinations of any of the foregoing. Many of these fillers can be further modified by sulfonation, carboxylation, phosphonation, amination, hydrolysis/condensation reactions and reactions with silanes to add functionality that improves wettability and/or ion conductivity.

When nanoparticulate fillers are present, adhesive and/or binder polymers can be present in the ion-selective coating as well. Non-limiting examples of adhesive and/or binder polymers include PVOH, acrylates, SBR emulsions, and combinations thereof.

As previously mentioned, the microporous polymer substrate or web is wettable with the aqueous electrolyte of the energy storage device to allow proton transport. For instance, the microporous polymer substrate can include a high surface area, hydrophilic filler distributed throughout the polymer matrix such that the volume fraction of filler divided by the volume fraction of polymer exceeds 0.75 or 1.0, such as between 0.75 and 1.3. In some embodiments, the high surface area, hydrophilic filler has a surface area greater than 100 m²/g. Examples of the hydrophilic fillers that can be used include an inorganic oxide, carbonate, or hydroxide, such as, for example, alumina, silica, zirconia, titania, mica, boehmite, magnesium hydroxide, calcium carbonate, and mixtures thereof. A preferred high-surface area, hydrophilic filler is precipitated or fumed silica.

For flow battery applications, the ion-selective composite membrane is chemically inert in the electrolyte of the flow battery. To that end, in some embodiments the microporous polymer substrate does not include a surfactant to aid in wettability of the polymer substrate. In other embodiments, the microporous polymer substrate does include a surfactant. Furthermore, any residual process oil should not be leached from the substrate over extended periods of use.

In some embodiments, the microporous polyolefin substrate comprises a thickness of 100 microns to 350 microns. The ion-selective coating comprises a thickness of 1 micron to 25 microns, or from 1 micron to 10 microns.

The composite membranes disclosed herein may provide enhanced durability, due at least in part from the presence of UHMWPE in the freestanding microporous polyolefin substrate. Accordingly, methods of making a battery separator with enhanced durability include providing or having provided a microporous polyolefin substrate having two major surfaces and comprising ultrahigh molecular weight polyethylene and coating one, or both, of the two major surfaces of the microporous polyolefin substrate with an ion-selective polymer material. The coating may be applied by spray coating, knife-over-roll coating, dip coating, rod coating, slot die coating, or gravure coating. Other coating methods may also be employed.

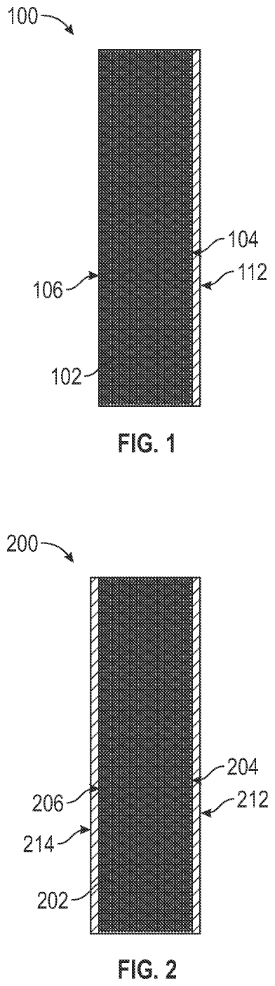

Illustrative composite membranes that can be made in accordance with the present disclosure are depicted in FIGS. 1 and 2. FIG. 1 is a cross-sectional schematic view of an asymmetric, composite membrane 100 having an ion-selective, non-porous coating layer 112 on one side of the membrane 100. As shown in FIG. 1, the composite membrane 100 includes a microporous polymer substrate 102 having a first major surface 104 and a second major surface 106. As further depicted in FIG. 1, the composite membrane 100 includes a first ion-selective, non-porous coating layer 112 disposed on one side (e.g., the first major surface 104) of the microporous polymer substrate 102.

FIG. 2 is a cross-sectional schematic view of a composite membrane 200 having ion-selective, non-porous coating layers 212, 214 on both sides of the membrane 200. As shown in FIG. 2, the composite membrane 200 includes a microporous polymer substrate 202 having a first major surface 204 and a second major surface 206. As further depicted in FIG. 2, the composite membrane 200 includes a first ion-selective, non-porous coating layer 212 disposed on a first side (e.g., the first major surface 204) of the microporous polymer substrate 202, and a second ion-selective, non-porous coating layer 214 disposed on a second side (e.g., the second major surface 206) of the microporous polymer substrate 202. It will thus be appreciated that the composite membrane 200 can be coated on one or both major surfaces 204, 206 as desired.

The following examples are illustrative in nature and not intended to be limited in any way.

### Example 1

An ENTEK grey web was manufactured by feeding a mixture of UHMVVPE (KPIC U090), precipitated silica (Solvay 565B), naphthenic process oil (Nytex 820), and small amounts of carbon black, antioxidant, and lubricant into a twin-screw extruder. Additional oil was added at the throat of the extruder, and the mixture was extruded at approximately 225 C through a sheet die into a calender stack. The extrudate contained about 65% oil, which was subsequently extracted to form a microporous polyolefin web having a thickness of about 204 um and a basis weight of about 95 g/m². The SiO2/PE mass ratio was about 2.6 (volume ratio about 1.12), and the residual oil content was about 2.4% as measured by thermogravimetric analysis. A Gurley value of 749 (secs/100 cc air) was measured for the web.

An ENTEK white web was manufactured by feeding a mixture of ultra-high molecular weight polyethylene (Celanese GUR 4130), precipitated silica (PPG SBG), mineral oil (Tufflo 6056), and a small amount of antioxidant into a twin-screw extruder. Additional oil was added at the throat of the extruder, and the mixture was extruded at approximately 225 C through a sheet die into a calender stack. The extrudate contained about 65% oil, which was subsequently extracted to form a microporous polyolefin sheet having a thickness of about 195 um and a basis weight of about 106 g/m 2. The silica/PE mass ratio was about 2.5 (volume ratio about 1.08), and the residual oil content was about 1.6% as determined by thermogravimetric analysis. A Gurley value of 1247 (secs/100 cc air) was measured for the web, and a porosity of about 65% was determined by Hg porosimetry.

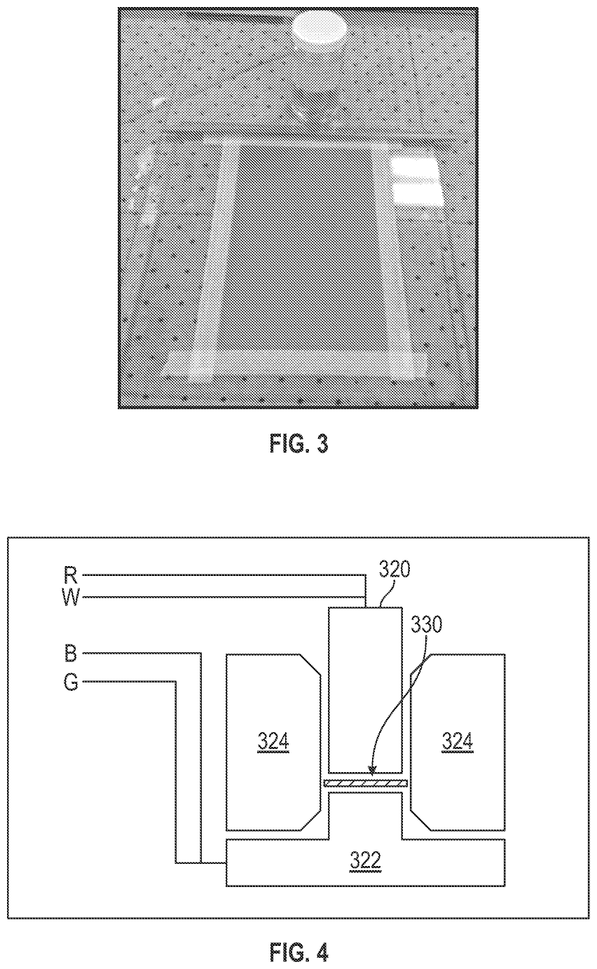

Samples of the ENTEK Grey web and the ENTEK White web were each coated with an ion-selective polymer solution (either 12% Kraton Nexar™ MD 9200 (a sulfonated block copolymer) or 12% Kraton Nexar™ MD 9204 (a sulfonated block copolymer)) using the following coating technique: Samples (cut pieces) of the microporous polymer webs (8 inches×12 inches) were taped to a glass plate to allow for single-sided coating. A thin layer of the ion-selective polymer solution (12% Kraton Nexar™ MD9200 or MD9204) was applied to the samples using different Mayer rod coaters. The coatings on the samples were dried using a hand-held heat gun for a couple of minutes until they were fully dry. An image of an exemplary coated microporous polymer web (i.e., a composite membrane) is depicted in FIG. 3.

After the coatings were dried, the coating weights were determined and the Gurley values of the samples were measured. A Gurley value of greater than 20,000 indicated that the coating was non-porous.

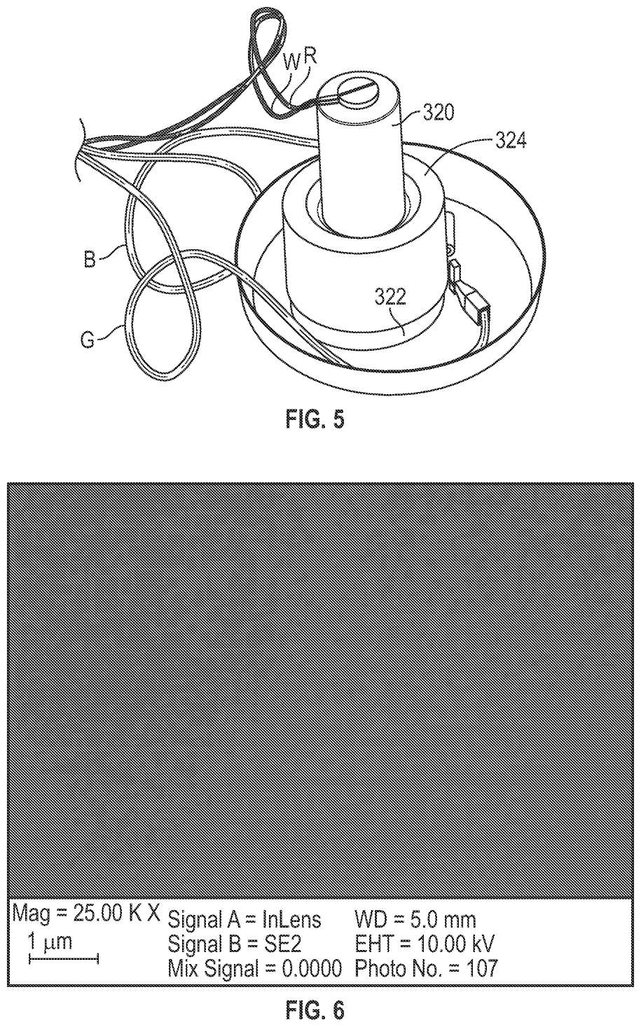

The electrical resistance (ER) of the samples was measured as follows: Three 0.75 inch diameter disks were punched from each sample and the thickness of each disk measured. The sample disks were placed in aluminum pans with 1.5M potassium chloride (KCl) solution and vacuum (29 inHg) was applied for 1 hour. Thereafter, the sample disks were soaked overnight in the 1.5M KCl. ER testing using a direct contact method was performed using the apparatus depicted in FIGS. 4 and 5. In particular, the saturated disks were placed between two stainless steel electrodes connected to a Gamry potentiostat, and an impedance measurement was made at 100 kHz with a voltage amplitude of 10 mV. The real component of the impedance at 100 kHz was recorded for the resistance value. Sample disks were tested individually and combination. The resistance value for one disk, two disks, and three disks was plotted. The slope of the line fitted to the three data points was used to determine the resistance for each disk. With reference to FIGS. 4 and 5, the schematic representation of the testing apparatus depicts the top electrode 320, bottom electrode 322, polytetrafluoroethylene (PTFE) insulator 324, sample 330, and leads R,W,B,G.

The Ion Exchange Capacity (IEC) of the samples was also calculated based on the coat weights and an IEC of 2.0 meq/g for both MD 9200 and MD 9204.

Tables detailing the base material, coating, ER, and IEC of various samples are set forth in Tables 1-3.

TABLE 1

| | | | | Coat | Gurley | ER | |
|---|---|---|---|---|---|---|---|
| | Base | Coating | Mayer | Weight | (sec/100 | (Ω- | IEC |
| Sample | Material | Solution | Rod # | (g/m²) | ml) | cm²) | (meq/m²) |
| 1 | ENTEK | — | — | — | 749 | 0.59 | 0 |
| | Grey | | | | | | |
| 2 | ENTEK | MD9204 | 0 | 4.67 | 18901 | 0.60 | 9.34 |
| | Grey | | | | | | |
| 3 | ENTEK | MD9204 | 4 | 6.72 | 21214 | 0.61 | 13.44 |
| | Grey | | | | | | |
| 4 | ENTEK | MD9204 | 8 | 16.74 | 20487 | 0.56 | 33.48 |
| | Grey | | | | | | |
| 5 | ENTEK | MD9204 | 12 | 18.02 | 22096 | 0.76 | 36.04 |
| | Grey | | | | | | |

TABLE 2

| | | | | Coat | Gurley | ER | IEC |
|---|---|---|---|---|---|---|---|
| Sam- | Base | Coating | Mayer | Weight | (sec/ | (Ω- | (meq/ |
| ple | Material | Solution | Rod # | (g/m²) | 100 ml) | cm²) | m²) |
| 6 | ENTEK | MD9200 | 0 | 5.10 | 16878 | 1.37 | 10.2 |
| | Grey | | | | | | |
| 7 | ENTEK | MD9200 | 4 | 5.18 | 18642 | 3.15 | 10.36 |
| | Grey | | | | | | |
| 8 | ENTEK | MD9200 | 8 | 8.18 | 20619 | 9.32 | 16.36 |
| | Grey | | | | | | |

TABLE 3

| | | | | Coat | Gurley | ER | |
|---|---|---|---|---|---|---|---|
| | Base | Coating | Mayer | Weight | (sec/ | (Ω- | IEC |
| Sample | Material | Solution | Rod # | (g/m²) | 100 ml) | cm²) | (meq/m²) |
| 9 | ENTEK | — | — | — | 1247 | 0.73 | 0 |
| | White | | | | | | |
| 10 | ENTEK | MD9204 | 0 | 7.59 | 23382 | 1.14 | 15.18 |
| | White | | | | | | |
| 11 | ENTEK | MD9200 | 0 | 6.88 | 24054 | 3.70 | 13.76 |
| | White | | | | | | |

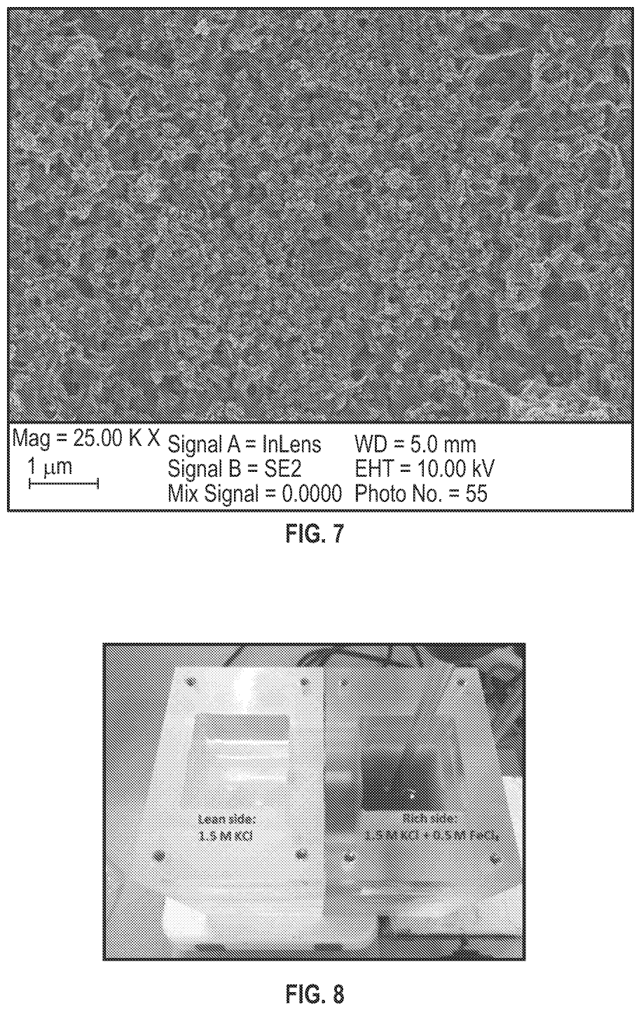

Scanning electron microscopy (SEM) was used to examine the composite membrane of Sample 10. FIG. 6 is an SEM image of a surface coated with the ion-selective polymer (Nexar MD 9204). As shown therein, the coated surface appears to be smooth and non-porous. FIG. 7 is an SEM image of the opposite, uncoated surface and its porosity.

### Example 2

An ENTEK grey web and an ENTEK white web were manufactured as set forth in Example 1. Samples of the ENTEK Grey web and the ENTEK White web were each coated as follows.

Single-sided Coating: In samples 16-17, cut pieces of the microporous polymer web (8 inches×12 inches) were taped to a glass plate to allow for single-sided coating. A thin layer of the ion-selective polymer solution (12% solids Kraton Nexar™ MD9200 or MD9204) was applied to the web using a mayer rod coater or a doctor blade. The polymer coating on the web was dried by placing the sample in a convection oven at 80 C for a couple of minutes until it was fully dry. In samples 18-30, the fully dry polymer coating was subsequently crosslinked by soaking the coated web in an aqueous solution containing 0.1-10 wt % of a polyfunctional aziridine crosslinking agent for approximately a minute. The particular polyfunctional aziridine crosslinking agents used were Pentaerythritol tris[3-(1-aziridinyl) propionate] (PTAP), PZ-28 and PZ-33 from PolyAziridine LLC, and Curing Agent X7 from ICHEMCO srl. The web with the crosslinked polymer coating was dried by placing the sample in a convection oven at 80 C for a couple of minutes until it was fully dry.

Double-sided Coating: In samples 31-34, a roll of microporous polymer web (150-200 mm wide) was coated on both sides by dip coating it through an ion-selective polymer solution (1-2% solids Kraton Nexar™ MD9204) and dried at 80° C. as part of a 2-step dip coating process on a laboratory scale continuous coating line. In a second step, the fully dry polymer coated web was passed through an aqueous solution containing 0.1-3 wt % of a polyfunctional aziridine crosslinking agent to crosslink the polymer coating. The web with the crosslinked polymer coating was dried at 80 C.

Single-step coating process: In example 35, a thin layer of the ion-selective Nexar™ MD9204 polymer was applied to the microporous polymer web (8 inches×12 inches) and crosslinked in a single-step process. This was done by mixing a GP® Crosslinking Resin/Kraton Nexar™ MD9204 (60/40), 20 wt % solids formulation and applying it to the web using a mayer rod coater or a doctor blade. The polymer coating on the web was dried by placing the sample in a convection oven at 100 C for a couple of minutes to fully dry and crosslink the coating.

Electric Resistance (ER) test method: The ER of the samples was measured as described in Example 1.

Rate of Ferric Chloride Crossover test method: A diffusion cell apparatus was used to measure the rate ferric chloride (FeCl₃) crossover through the microporous polymer web samples. A picture of the apparatus is shown in FIG. 8. As shown therein, the diffusion cell had 0.5 M FeCl₃+1.5 M KCl on the concentrated or “rich” side and 1.5 M KCl (acidified with hydrochloric acid (HCl)) on the dilute or “lean” side. The sample sheets (4-inch×4-inch) were placed in aluminum pans with deionized water and vacuum (29 inHg) was applied for 1 hour. The saturated samples were placed between the two cell blocks and 400 ml of each solution were poured into the two sides of the diffusion cell simultaneously. 3 ml samples were taken from the dilute side periodically (for example, after 10, 20, 30 minutes) and pipetted into cuvettes for absorbance testing. Absorbance at 334 nm wavelength was measured using a Thermo-fisher Scientific UV-vis spectrophotometer. In the ideal case, a free-standing ion-selective composite membrane would exhibit no Fe crossover while still enabling proton (W) transport between the cells.

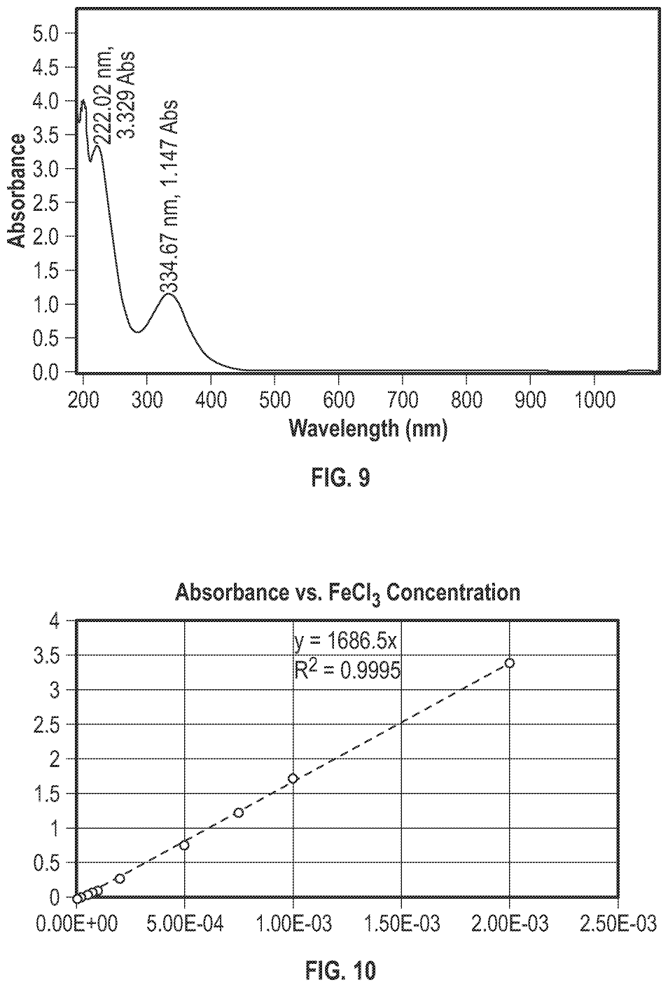

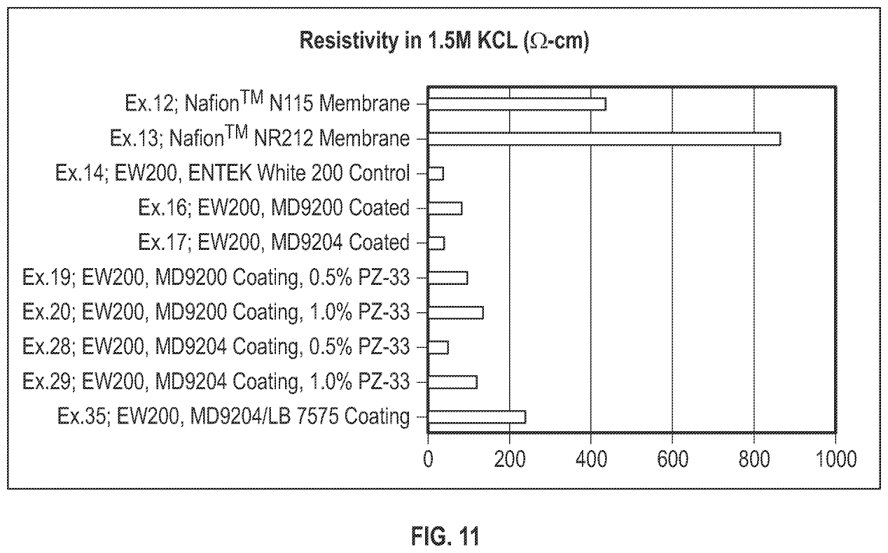

An exemplary graph demonstrating the absorbance vs. wavelength is shown in FIG. 9. The FeCl 3 concentration of the samples was then determined from a calibration curve of absorbance vs. FeCl 3 concentration. An exemplary graph of a calibration curve showing absorbance vs. ferric chloride concentration is shown in FIG. 10.

A table detailing the base material, coating, ER, and ferric chloride diffusion rate of various samples is set forth in Table 4. Samples 12 and 13 were commercially available Nafion™ membranes from Fuelcellstore.com that were used as comparative samples. Sample 12 (Nafion™ N115) was a 126 μm thick membrane, and Sample 13 (Nafion™ NR 212) was a 47 μm thick membrane.

TABLE 4

| | | | | | | | | | FeCl₃ |
|---|---|---|---|---|---|---|---|---|---|
| | | | | | | Wt | ER | | Diffusion |
| | Base | Coating | | | | Pickup | (Ω- | Resistivity | Rate |
| Sample | Material | method | Polymer | Crosslinker | | (g/m²) | cm²) | (Ω-cm) | (mol/hr/m²) |
| 12 | Nafion ™ | — | — | — | | — | 5.45 | 432 | 0.081 |
| | N115 | | | | | | | | |
| 13 | Nafion ™ | — | — | — | | — | 4.06 | 863 | 0.0340 |
| | NR212 | | | | | | | | |
| 14 | ENTEK | — | — | — | | — | 0.73 | 38 | 1.217 |
| | White | | | | | | | | |
| 15 | ENTEK | — | — | — | | — | 0.53 | 30 | 1.633 |
| | Grey | | | | | | | | |
| 16 | ENTEK | Single- | MD9200 | — | | 4.36 | 1.67 | 86 | 0.8060 |
| | White | Sided | | | | | | | |
| 17 | ENTEK | Single- | MD9204 | — | | 9.97 | 0.84 | 41 | 0.9992 |
| | White | Sided | | | | | | | |
| 18 | ENTEK | Single- | MD9200 | 1.0% | PZ-28 | 6.18 | 1.56 | 79 | 0.0127 |
| | White | Sided | | | | | | | |
| 19 | ENTEK | Single- | MD9200 | 0.5% | PZ-33 | 3.32 | 1.98 | 100 | 0.0051 |
| | White | Sided | | | | | | | |
| 20 | ENTEK | Single- | MD9200 | 1.0% | PZ-33 | 2.88 | 2.72 | 137 | 0.0006 |
| | White | Sided | | | | | | | |
| 21 | ENTEK | Single- | MD9200 | 0.5% | PZ-33 | 2.36 | 1.33 | 70 | 0.0031 |
| | Grey | Sided | | | | | | | |
| 22 | ENTEK | Single- | MD9204 | 1.0% | PTAP | 31.88 | 0.86 | 37 | 0.0816 |
| | White | Sided | | | | | | | |
| 23 | ENTEK | Single- | MD9204 | 10% | PTAP | 37.84 | 2.97 | 133 | 0.0016 |
| | White | Sided | | | | | | | |
| 24 | ENTEK | Single- | MD9204 | 0.5% | X7 | 16.71 | 1.29 | 59 | 0.0193 |
| | White | Sided | | | | | | | |
| 25 | ENTEK | Single- | MD9204 | 0.5% | X7 | 4.88 | 1.14 | 62 | 0.0073 |
| | Grey | Sided | | | | | | | |
| 26 | ENTEK | Single- | MD9204 | 1.0% | PZ-28 | 13.27 | 1.56 | 76 | 0.1103 |
| | White | Sided | | | | | | | |
| 27 | ENTEK | Single- | MD9204 | 0.1% | PZ-33 | 17.83 | 1.12 | 54 | 0.0486 |
| | White | Sided | | | | | | | |
| 28 | ENTEK | Single- | MD9204 | 0.5% | PZ-33 | 20.29 | 1.10 | 53 | 0.0383 |
| | White | Sided | | | | | | | |
| 29 | ENTEK | Single- | MD9204 | 1.0% | PZ-33 | 18.68 | 2.53 | 125 | 0.0073 |
| | White | Sided | | | | | | | |
| 30 | ENTEK | Single- | MD9204 | 0.5% | PZ-33 | 13.66 | 2.79 | 145 | 0.0038 |
| | Grey | Sided | | | | | | | |
| 31 | ENTEK | Double- | 1.5% | 1.0% | PZ-33 | 5.20 | 1.80 | 88 | 0.0110 |
| | White | sided | MD9204 | | | | | | |
| 32 | ENTEK | Double- | 1.5% | 1.0% | PZ-33 | 3.58 | 1.31 | 71 | 0.0440 |
| | Grey | sided | MD9204 | | | | | | |
| 33 | ENTEK | Double- | 1.5% | 2.0% | PZ-33 | 4.00 | 3.61 | 197 | 0.0020 |
| | Grey | sided | MD9204 | | | | | | |
| 34 | ENTEK | Double- | 1.5% | 3.0% | PZ-33 | 4.56 | 4.36 | 230 | 0.0040 |
| | Grey | sided | MD9204 | | | | | | |
| 35 | ENTEK | Single- | 10% | 20% | LB | 6.11 | 4.77 | 239 | 0.0030 |
| | White | step, | MD9204 | 7575 | | | | | |
| | | Single- | | | | | | | |
| | | sided | | | | | | | |

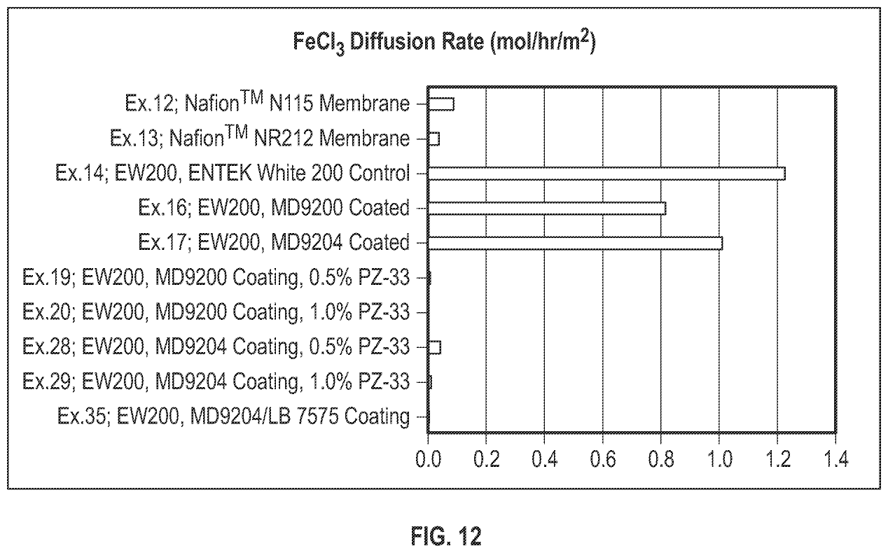

The resistivity and ferric chloride diffusion rates of various samples were also graphed and compared in FIGS. 11 and 12, respectively. As shown therein, the resistivity for each of the samples was less than the comparative Nafion™ membranes. Further, the ferric chloride diffusion rates were reduced by crosslinking. These data exemplify the benefits of crosslinking to reduce crossover of Fe³⁺ (or another cation) to less than 0.1 mol/hr/m² while maintaining a low electrical resistivity (such as less than 250 Ω-cm).

As can be appreciated, this disclosure pertains to structures and methods of making the same. Any methods disclosed or contemplated herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment.

References to approximations are made throughout this specification, such as by use of the terms “substantially” and “about.” For each such reference, it is to be understood that, in some embodiments, the value, feature, or characteristic may be specified without approximation. For example, where qualifiers such as “about” and “substantially” are used, these terms include within their scope the qualified words in the absence of their qualifiers.

Unless otherwise stated, all ranges include both endpoints and all numbers between the endpoints.

Recitation in the claims of the term “first” with respect to a feature or element does not necessarily imply the existence of a second or additional such feature or element.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. Moreover, the order of the steps or actions of the methods disclosed herein may be changed by those skilled in the art without departing from the scope of the present disclosure. In other words, unless a specific order of steps or actions is required for proper operation of the embodiment, the order or use of specific steps or actions may be modified. The scope of the invention is therefore defined by the following claims and their equivalents.

1. A composite membrane comprising:
a freestanding, microporous polyolefin substrate comprising a polyolefin and a hydrophilic filler, the microporous polyolefin substrate having a porosity of 40-75% that extends from a first major surface to a second major surface,
wherein the hydrophilic filler is distributed throughout the substrate and in which a volume fraction of hydrophilic filler divided by a volume fraction of polyolefin is greater than 0.75 thereby making the substrate wettable, and
wherein at least one of the first and second major surfaces comprises a non-porous coating of an ion-selective polymer, wherein the coating is crosslinked.

2. The composite membrane of claim 1, wherein at least one major surface comprises open pores, readily penetrable by an aqueous electrolyte into the porosity of the substrate.

3. The composite membrane of claim 1, wherein both major surfaces are coated with the ion-selective polymer.

4. The composite membrane of claim 1, wherein the ion-selective polymer is selective for either anions or cations.

5. The composite membrane of claim 4, wherein the ion-selective polymer is selective for cations.

6. The composite membrane of claim 5, wherein a diffusion rate of cations through the composite membrane is less than 0.1 mol/hr/m².

7. The composite membrane of claim 6, wherein an electrical resistivity of the composite membrane is less than 250 Ω-cm.

8. The composite membrane of claim 1, wherein the coating of the ion-selective polymer further comprises nanoparticulate fillers.

9. The composite membrane of claim 1, wherein the microporous polyolefin substrate further comprises a surfactant.

10. The composite membrane of claim 1, wherein the microporous polyolefin substrate comprises less than 3% of a residual process oil.

11. The composite membrane of claim 1, wherein the microporous polyolefin substrate has a thickness of 100 microns to 350 microns.

12. The composite membrane of claim 1, wherein the coating of the ion-selective polymer has a thickness of 1 micron to 25 microns, or 1 micron to 10 microns.

13. The composite membrane of claim 1, wherein the coating is crosslinked via irradiation, free radicals, or chemical cross-linking.

14. The composite membrane of claim 13, wherein the coating is crosslinked via chemical crosslinking with a crosslinking agent, wherein the crosslinking agent comprises a polyfunctional aziridine, a polyfunctional isocyanate, an epoxide, an amine, a phenolic, or an anhydride.

15. The composite membrane of claim 1, wherein the microporous polyolefin substrate comprises ultra-high molecular weight polyethylene and provides extended mechanical strength to the composite membrane.

16. A flow battery, comprising:
a composite membrane comprising:
a freestanding, microporous polyolefin substrate comprising a polyolefin and a hydrophilic filler, the microporous polyolefin substrate having a porosity of that extends from a first major surface to a second major surface,
wherein the hydrophilic filler is distributed throughout the substrate and in which a volume fraction of hydrophilic filler divided by a volume fraction of polyolefin is greater than 0.75 thereby making the substrate wettable, and
wherein at least one of the first and second major surfaces comprises a non-porous coating of an ion-selective polymer, wherein the coating is crosslinked.

17. The flow battery of claim 16, wherein at least one major surface comprises open pores, readily penetrable by an aqueous electrolyte into the porosity of the substrate.

18-20. (canceled)

21. The flow battery of claim 16, wherein a diffusion rate of cations through the composite membrane is less than 0.1 mol/hr/m².

22. The flow battery of claim 21, wherein an electrical resistivity of the composite membrane is less than 250 Ω-cm.

23-30. (canceled)

31. A method of making a separator with enhanced durability, the method comprising:
providing or having provided a microporous polyolefin substrate having two major surfaces and comprising ultrahigh molecular weight polyethylene;
coating at least one major surface of the microporous polyolefin substrate with an ion-selective polymer; and
crosslinking the ion-selective polymer.

32-45. (canceled)
